(19) United States
(12) Patent Application Publication
(10) Pub. No.: US 2022/0297330 A1
(43) Pub. Date: Sep. 22, 2022

(54) SLICING APPARATUS AND METHOD OF USING, ASSEMBLING AND DISASSEMBLING SAME

(71) Applicant: Maxwell Chase Technologies, LLC, Atlanta, GA (US)

(72) Inventors: Tom Gautreaux, Atlanta, GA (US); Ivan Stanojevic, Atlanta, GA (US); Neal D. Watson, Atlanta, GA (US)

(21) Appl. No.: 17/596,069

(22) PCT Filed: Jun. 8, 2020
(86) PCT No.: PCT/US20/36550

§ 371 Date: Dec. 2, 2021

Related U.S. Application Data
(60) Provisional application No. 62/858,541, filed on Jun. 7, 2019.

(51) Int. Cl. B26D 3/26; B26D 1/553; B26D 7/06

(52) U.S. Cl. CPC B26D 3/26; B26D 1/553; B26D 7/0608

(57) ABSTRACT

A slicing apparatus including at least one pusher head and at least one blade. The pusher head is movable from a first position, wherein an object to be sliced is capable of being placed between the pusher head and the blade, and a second position, wherein the pusher head contacts and/or pushes the object to be sliced against the at least one blade.

### CROSS-REFERENCE TO RELATED APPLICATION

The application claims priority to U.S. Provisional Patent Application No. 62/858,541, filed Jun. 7, 2019 and titled “SLICING APPARATUS AND METHOD OF USING, ASSEMBLING AND DISASSEMBLING SAME,” which is hereby incorporated by reference in its entirety.

### FIELD

The presently disclosed technology relates generally to an apparatus or assembly configured to slice or otherwise cut one or more objects (e.g., produce, such as tomatoes and onions, vegetables, such as potatoes, and/or fruit, such as apples, for example), and methods of using same.

### BACKGROUND AND DESCRIPTION OF RELATED ART

There are a variety of known systems and methods to slice or otherwise cut objects, such as foodstuff. There are generally several types of slicing or cutting apparatuses: manual (e.g., a hand slicer), automated and semi-automated.

Examples of prior art devices are described in U.S. Pat. No. 8,069,763 (Stanojevic), U.S. Pat. No. 8,474,357 (Stanojevic), and U.S. Pat. No. 7,861,629 (Brander). Each of these systems or methods can be beneficial.

However, prior art slicers can be complicated, expensive, difficult to use, and difficult to repair or replace certain components.

Further, certain prior art slicers are built to include angled surfaces to prevent the accumulation of sitting water, which could become stagnant and therefore undesirable. These prior art slicers can be complicated or expensive to manufacture due to the angled surfaces. In particular, creating permanently angled surfaces can require more calculations and/or material as compares to slicers with flat or level surfaces. Neither additional time to design, nor additional material requirements, to conform to sanitary design standards is desirable.

### BRIEF SUMMARY

Embodiments of the presently disclosed technology overcome certain drawbacks of prior art designs and satisfy the above-outlined and other objectives.

In one aspect, the slicing apparatus of the presently disclosed technology is considered a manual or semi-automated device, as opposed to a fully automated device.

In another aspect, the assembly of the presently disclosed technology only requires an operator to perform one single step, such as placing foodstuff in the assembly to be sliced. In this respect, it involves a simpler process requiring a less sophisticated operator than with prior art devices.

Optionally, the assembly can be plugged into an electrical outlet to provide power to one or more components of the assembly.

In any optional embodiment, the assembly does not require or use components powered by pneumatic means.

In any optional embodiment, the assembly does not require or utilize suction cups. In addition, the assembly optionally does not include angled surfaces to prevent the accumulation of stagnant water or other liquid. Instead, the assembly can optionally include adjustable legs, feet, and/or wheels, which allows a user to selectively angle at least portions of the assembly to prevent the accumulation of liquids thereon.

Optionally, the assembly includes one or more spaced-apart pusher heads. Each pusher head can optionally move downwardly from a first or upper position to contact downwardly press an object to be sliced or cut.

In any optional embodiment, one or more blades are positioned beneath the object(s) to be sliced or cut and/or beneath each pusher head.

Optionally, each blade is stationary during the cutting or slicing procedure.

Optionally, in any embodiment adjacent blades of the assembly are approximately ⅛^{th} inch apart, optionally from ¼ to 1/16 inch apart.

Optionally, in any embodiment, a cutting or slicing surface of each blade is different at opposing ends of the blade as compared to a mid-portion of the blade.

In any optional embodiment, the presently disclosed technology utilizes one or more linear bearings, which results in easier replacement of the bearings when necessary or desirable.

Optionally, the assembly can include at least one or two spaced-apart conveyors to move whole and/or sliced objects.

### BRIEF DESCRIPTION OF SEVERAL VIEWS OF THE DRAWINGS

The foregoing summary, as well as the following detailed description of the invention, will be better understood when read in conjunction with the appended drawings, wherein like numerals designate like elements throughout. For the purpose of illustrating the invention, there are shown in the drawings various illustrative embodiments. It should be understood, however, that the presently disclosed technology is not limited to the precise arrangements and instrumentalities shown. In the drawings:

FIG. 1 is a top perspective view of a slicing apparatus according to an embodiment of the presently disclosed technology;

FIG. 2 is another top perspective view of the slicing apparatus shown in FIG. 1, wherein FIG. 2 is taken from an opposite side from that shown in FIG. 1;

FIG. 3 is a front elevation view of the slicing apparatus shown in FIG. 1, wherein the front side of the apparatus is that visible in FIG. 1;

FIG. 4 is a magnified perspective view of a portion of the slicing apparatus shown in FIG. 1, wherein certain aspects of the slicing apparatus are omitted for clarity;

FIG. 5 is a magnified front elevation view of a portion of the slicing apparatus shown in FIG. 1, wherein one aspect of the slicing apparatus is shown as transparent for clarity and wherein a portion of the slicing apparatus is shown in a first or upper position;

FIG. 5A is a cross-sectional view of the portion of the assembly shown in FIG. 5, taken from the perspective of line A-A in FIG. 2 and with the objects-to-be sliced removed for clarity;

FIG. 6 is a magnified front elevation view of a portion of the slicing apparatus shown in FIG. 1, wherein one aspect of the slicing apparatus is shown as transparent for clarity and wherein a portion of the slicing apparatus is shown in a second or lower position;

FIG. 6A is a cross-sectional view of the portion of the assembly shown in FIG. 6, taken from the perspective of line A-A in FIG. 2 and with the objects-to-be sliced removed for clarity;

FIG. 7 is a perspective view of a portion of the slicing assembly shown in FIG. 1;

FIG. 7A is a partially exploded perspective view of the portion of the slicing assembly shown in FIG. 7;

FIG. 8 is a side elevation view of a portion of the slicing assembly shown in FIG. 1;

FIG. 9 is a top plan view of a portion of the slicing assembly shown in FIG. 1;

FIG. 9A is a cross-sectional view of the portion of the slicing assembly shown in FIG. 9, taken along line B-B of FIG. 9;

FIG. 10 is a front elevation view of a portion of the slicing assembly shown in FIG. 1;

FIG. 10A is a cross-sectional view of the portion of the slicing assembly shown in FIG. 10, taken along line C-C in FIG. 10;

FIG. 11 is a perspective view of a pusher header of the slicing assembly shown in FIG. 1;

FIG. 12 is a bottom perspective view of the pusher header of FIG. 11;

FIG. 13 is a top perspective view of a slicing apparatus according to another embodiment of the presently disclosed technology;

FIG. 14 is another top perspective view of the slicing apparatus shown in FIG. 13, wherein FIG. 2 is taken from an opposite side from that shown in FIG. 1; and

FIG. 15 is a front elevation view of the slicing apparatus shown in FIG. 13.

### DETAILED DESCRIPTION

While systems, devices and methods are described herein by way of examples and embodiments, those skilled in the art recognize that the systems, devices and methods of the presently disclosed technology are not limited to the embodiments or drawings described. It should be understood that the drawings and description are not intended to be limited to the particular form disclosed. Rather, the invention covers all modifications, equivalents and alternatives falling within the spirit and scope of the appended claims.

Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to. Unless specifically set forth herein, the terms “a,” “an” and “the” are not limited to one element but instead should be read as meaning “at least one.” The terminology includes the words noted above, derivatives thereof and words of similar import.

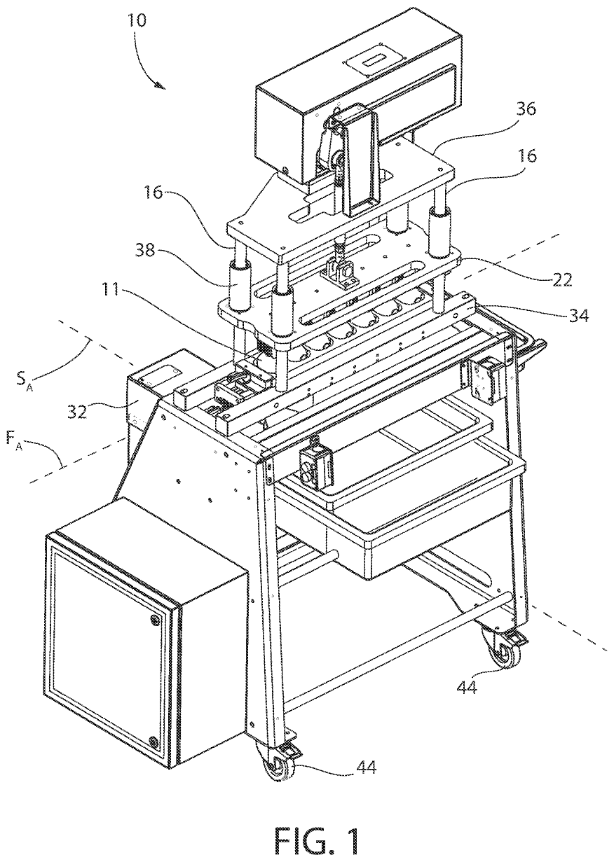

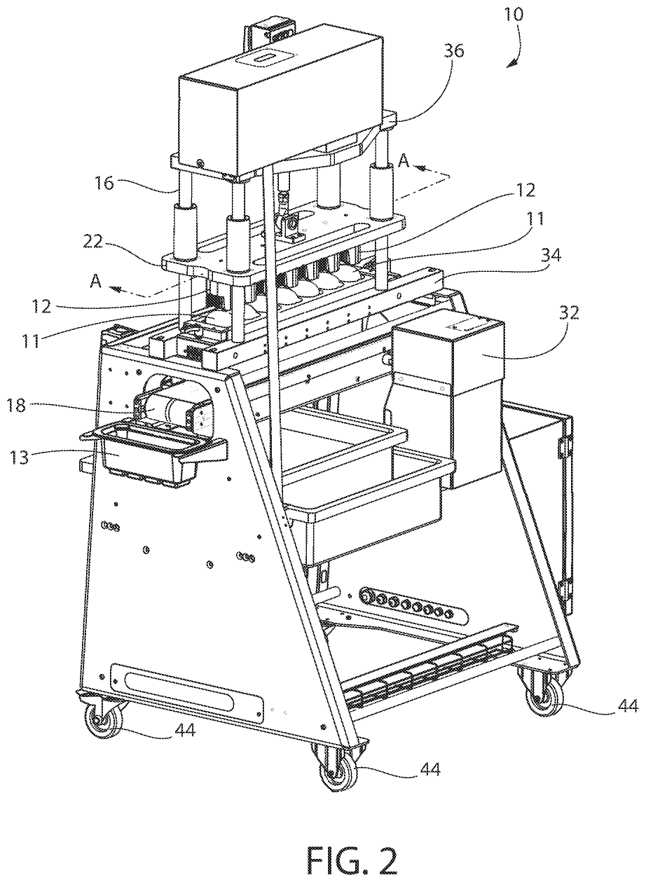

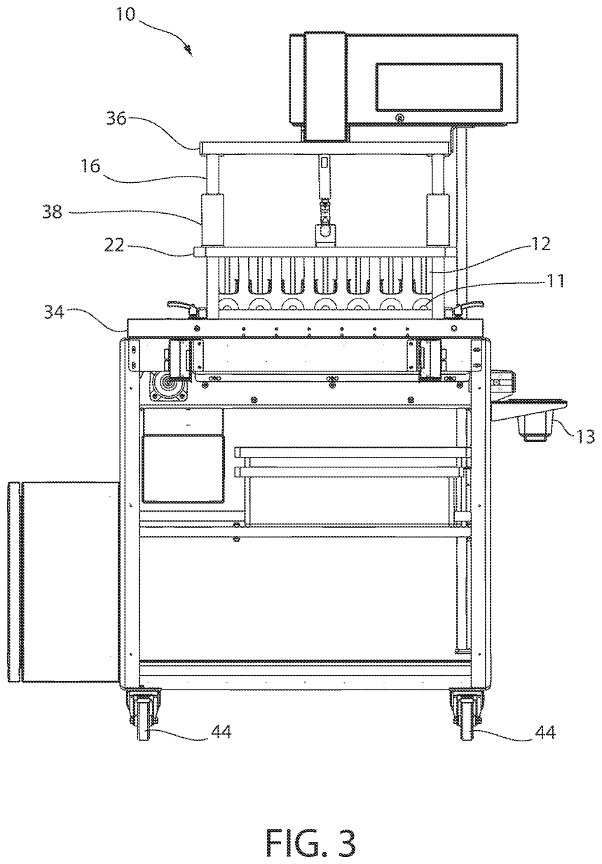

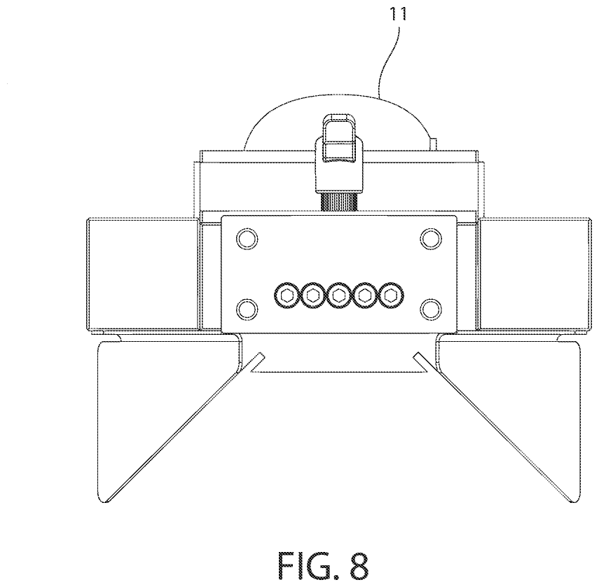

Referring to the drawings in detail, wherein like numerals indicate like elements throughout, FIGS. 1-12 illustrate an optional embodiment of a slicing system, device or assembly (these nouns may be used herein interchangeably), generally designated 10, and aspects thereof. In any optional embodiment, the assembly 10 is configured to slice or otherwise cut one or more (e.g., a plurality of spaced-apart) objects 11, such as but not limited to foodstuff, optionally produce. Non-limiting examples of foodstuff that can be readily cut or sliced by the assembly 10 include tomatoes (such as Roma tomatoes), onions, lemons, limes, and/or other fruit and vegetables, particularly those that are generally rounded with distinct ends (wherein the ends may be undesirable for consumption and are preferably discarded before consumption of the remainder of the object).

In any optional embodiment, the assembly 10 allows a single user to simultaneously slice several objects 11 at one time. Optionally, the assembly allows a single user to slice several objects 11 (e.g., tomatoes), optionally twenty to fifty, optionally approximately thirty-five tomatoes, optionally Roma tomatoes, per minute and ultimately places the sliced portions in a tray. Optionally, the assembly 10 automatically, quickly and/or easily separates ends of the object(s) 11, which in certain applications (e.g., tomatoes) are generally undesirable, from more interior or “good” slices of the object(s) 11. In any optional embodiment, the assembly 10 automatically, quickly and/or easily conveys or otherwise moves the “good” slices or cuts (i.e., slices from the produce not including the ends thereof) to a first location, such as tray 13 or other receptacle or holding area, while the “bad” slices are moved or allowed to move to a second location separate and distinct from the tray.

The assembly 10 is optionally designed to be easy to make, assemble and/or use. In any embodiment, the assembly 10 is modular in construction. In addition, the user can optionally quickly change the thickness of the slices. For example, if one or more of the components of the assembly 10 become undesirably worn (e.g., dull) or otherwise not desirable, those particular components can be easily and quickly replaced without necessarily replacing or even removing other components that are in satisfactory condition. For example, single blades or a unitary set of blades may be readily removed and replaced when necessary. The assembly 10 is optionally easy to maintain (e.g., simple), and can be in “plug-and-play” form.

In any embodiment, the assembly 10 can optionally include at least one pusher head 12, at least two spaced-apart blades 14 (e.g., as part of a set of blades), and at least one shaft or pole 16. Optionally, the at least one pusher head 12 is movable from a first or upper position wherein the object 11 is capable of being placed between the at least one pusher head 12 and the at least two spaced-apart blades 14, and a second or lower position wherein the at least one pusher head 12 contacts and/or pushes the object(s) 11 against, to, and/or past an upper surface of each of the at least two spaced-apart blades 14. Optionally, the at least one pusher head 12 moves with respect to the at least two spaced-apart blades 14, and/or each of the at least two spaced-apart blades 14 is stationary during the slicing or cutting process.

The at least one pusher head 12 can optionally include a plurality of spaced-apart pusher heads 12. In such an embodiment, each pusher head 12 can be placed along a line or linear path extending across a width of the assembly 10. In one optional embodiment, the plurality of spaced-apart pusher heads 12 include eight spaced-apart pusher heads 12. The spacing between the pusher heads 12 can be fixed or adjustable to accommodate objects of different sizes and/or types.

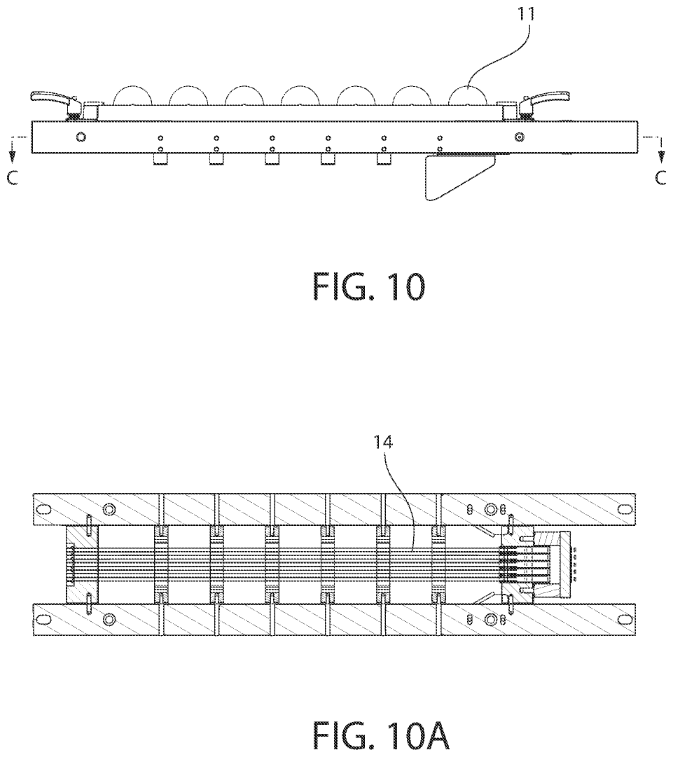

The at least two spaced-apart blades 14 can optionally include a plurality of spaced-apart blades 14. In one optional embodiment, such as that shown in FIG. 10A, the plurality of spaced-apart blades 14 include from five to twenty, optionally ten spaced-apart blades 14. Each blade 14 can extend along a line or linear path extending across a width of the assembly 10.

In any optional embodiment, a cutting portion of each blade 14 is different at one or both ends of the blade 14 than in a mid-portion of the blade 14. Optionally, at least a portion (e.g., a top surface) of each blade 14 has a V or scalloped shape. More particularly, in any optional embodiment, a top surface of each blade 14 includes a series of scalloped shapes, which can enable the assembly to cleanly and/or neatly slice the object(s) 11.

The at least one shaft 16 can optionally include a plurality of spaced-apart linear shafts 16. In one optional embodiment, the plurality of spaced-apart shafts 16 include four spaced-apart linear shafts 16, optionally arranged in a rectangular formation when viewed from above or below. Each shaft 16 can extend vertically and/or perpendicular to the direction in which the plurality of pusher heads 12 extend and/or the two spaced-apart blades 14 extend.

Each shaft 16 can optionally be in tubular or cylindrical form. In any optional embodiment, each shaft 16 can form a portion of a frame of the assembly 10. Optionally, each shaft 16 is stationary and/or fixedly attached to other portions of the frame of the assembly 10. For example, a lower end of each shaft 16 can optionally be fixedly or removably attached to a base 34 and an upper end of each shaft 16 can optionally be fixedly or removably attached to a platform 36. Both the base 34 and the platform 36 can optionally be flat or planar components and extend in a plane parallel to a ground surface that supports the assembly 10.

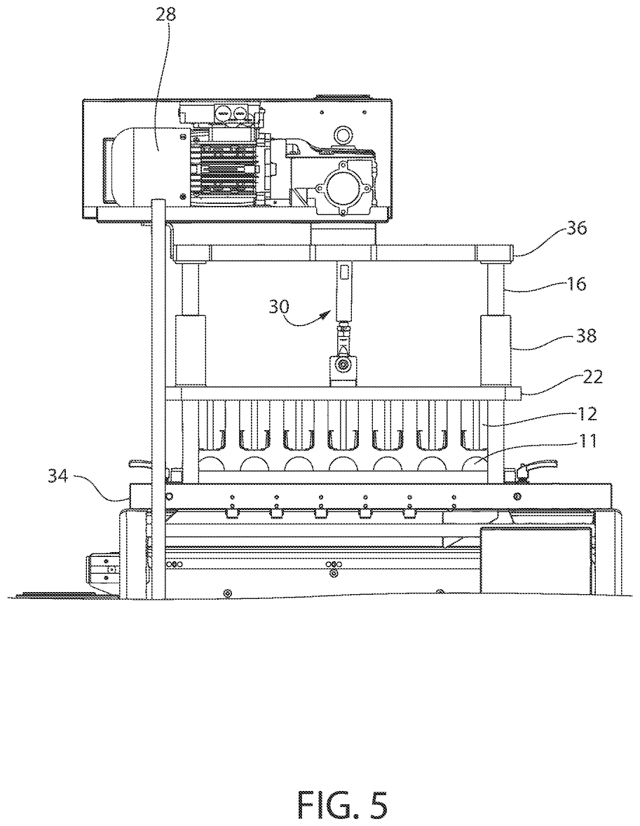

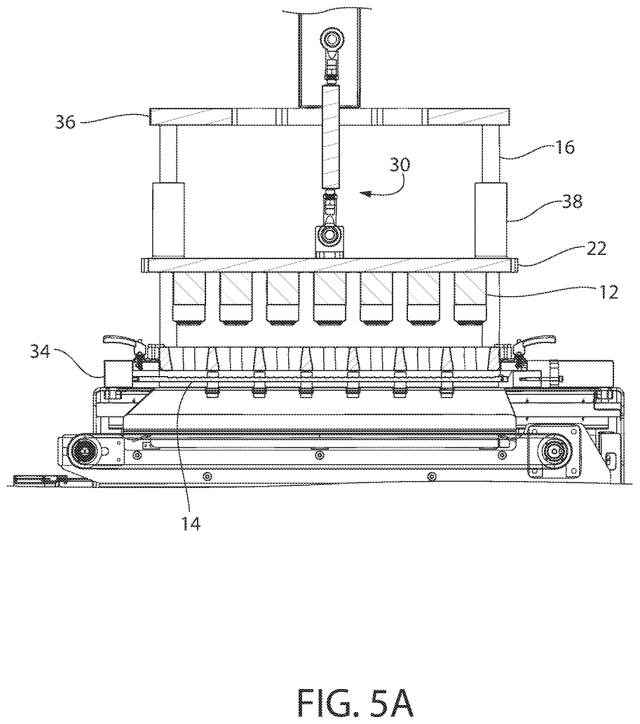

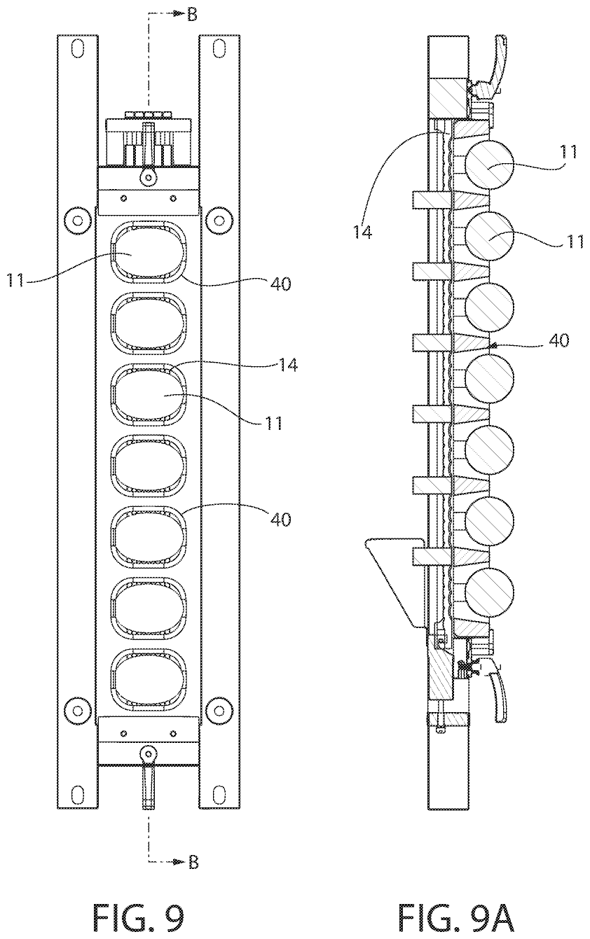

Optionally, as shown in FIGS. 5A and 9, at least a portion of the base 34 can include at least one or a plurality of spaced-apart cavities, holding basins, or craters 40. Each cavity 40 can be sized, shaped and/or configured to hold or support one object 11 in a stationary position. Optionally, each cavity 40 is formed in the base 34 so as to surround approximately half of one of the objects 11, such that a remainder (e.g., upper portion) of the object 11 is exposed.

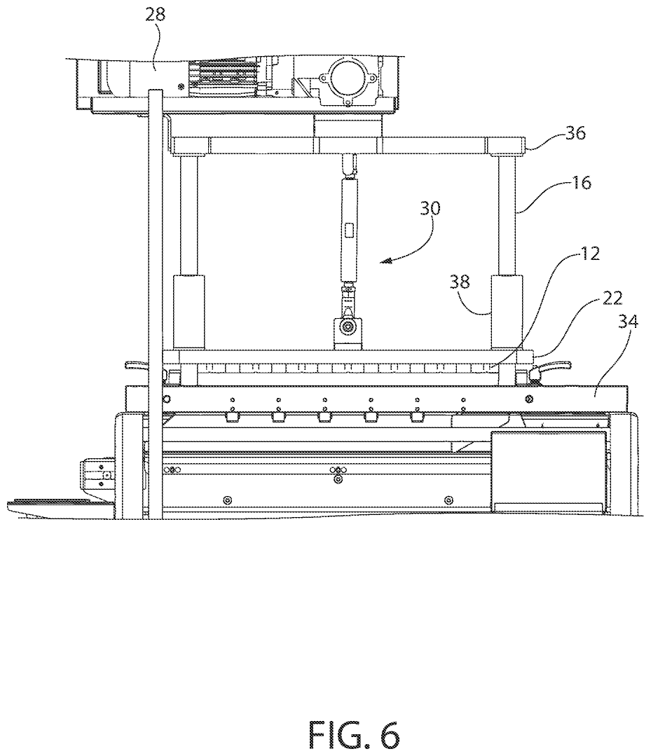

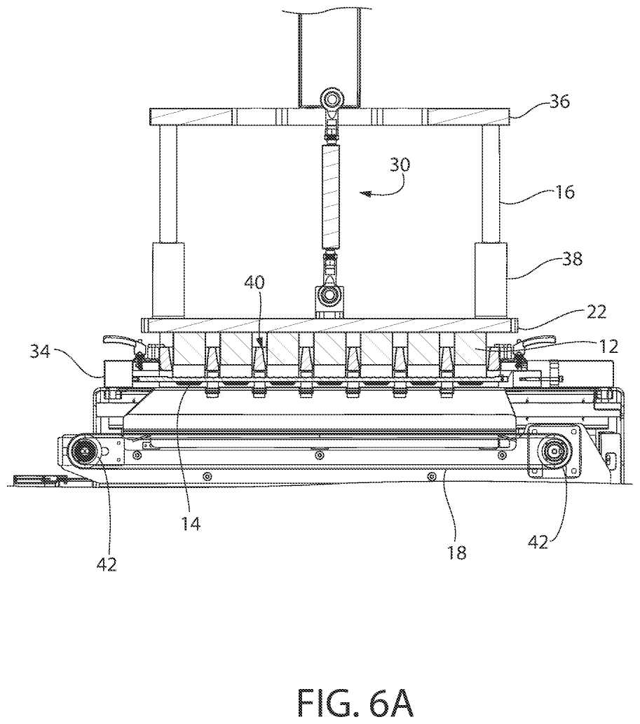

As shown in FIGS. 5A and 6A, a width or diameter of each cavity 40 is optionally at least slightly larger than a width or diameter of each pusher head 12, such that a pusher head 12 can move at least partially into one of the cavities 40 to push the object 11 past the blades 14 without damaging or impeding movement of the pusher head 12. Further, as shown in FIG. 10, each cavity 40 can include slanted or angled sidewalls, wherein a lower opening of each cavity 40 is at least slightly smaller (e.g., in width or diameter) than an upper opening of each cavity 40. Such a configuration can create a preferred holding position for each object 11 to be sliced.

The base 34 can optionally hold or support each blade 14 in a stationary configuration. In one embodiment, each blade 14 is fixed with respect to the base 34. More particularly, each end of each blade 14 is secured to a portion of the base 34, such that any portion of the blade 14 between the two ends thereof is free or unattached. The base 32 can also be configured to allow the user to selectively move adjacent blades 14 closer together or further apart (e.g., in a direction perpendicular to that which each blade 14 extends) to change the thickness of the slice(s) of the object(s) 11.

In any optional embodiment, the plurality of spaced-apart pusher heads 12 are spaced-apart along a first axis F_{A}, as shown in FIG. 1. In any optional embodiment, the plurality of spaced-apart blades 14 are spaced-apart along a second axis S_{A}, as shown in FIG. 1. Optionally, the blades 14 extend parallel to one another. The first axis FA can optionally extend in a direction ninety degrees (e.g., perpendicular) with respect to the second axis S_{A}.

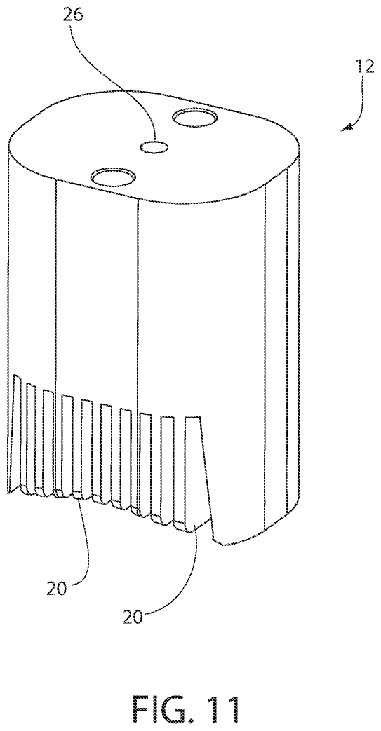

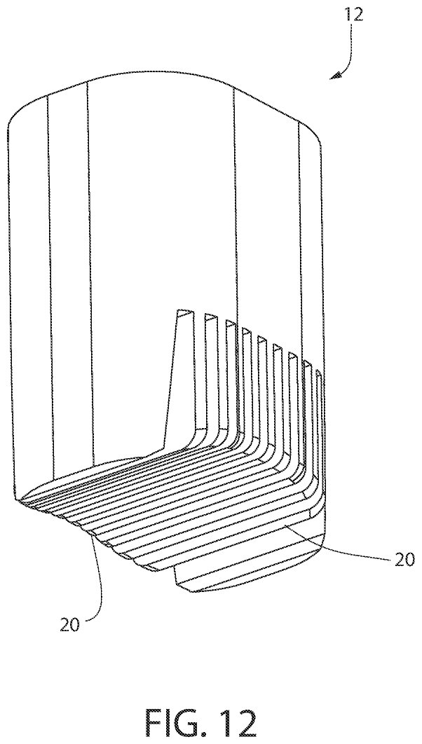

Referring now to FIGS. 11 and 12, each pusher head 12 can optionally include an arcuate lower or bottom surface. More specifically, the lower surface of each pusher head 12 can be concave such that the lower surface is curved upwardly toward a geometric center of the pusher head 12. The arcuate shape can be configured to apply pressure to one of the objects 11 (e.g., generally spherical, oval, or oblong objects) in a uniform or even manner, which helps not to undesirably damage the object during slicing.

As shown in FIGS. 11 and 12, each pusher head 12 can optionally include a plurality of spaced-apart fins 20. The fins 20 can be spaced-apart along the first axis FA. In one optional embodiment, the plurality of spaced-apart fins 20 include eight or ten spaced-apart linear fins 20. A distance between each adjacent fin 20 can optionally be at least slightly larger than a width of one of the blades 14. Similarly, a distance between each adjacent blade 14 can optionally be at least slightly larger than a width of one of the fins 20.

The fins 20 and/or the pusher heads 12 can be formed at least partially of a generally flexible or forgiving material, such that the fins 20 and/or the pusher heads 12 do not damage or bruise the objects 11 when the pusher head pushes the object. In one optional embodiment, the fins 20 and/or at least a portion of each pusher head 12 can be formed of a rubber, an elastomer, and/or an elastomeric material. However, any material that does not damage or bruise the object 11 to be sliced can be used to form at least a portion of the fins 20 and/or the pusher heads 12. In one optional embodiment, an upper end of each pusher head 12 can be formed of a generally rigid or hard material (e.g., hard plastic or metal), while a lower end of each pusher head 12 (e.g., the fins 20 or a portion thereof) can be formed of a soft or softer material (e.g., rubber).

Optionally, in operation, as each pusher head 12 moves from the upper position (see FIGS. 5 and 5A) to the lower position (see FIGS. 6 and 6A), a given fin 20 moves between two respective adjacent blades 14 to push the object 11 past the blades 14 and thereby slice the object 11.

Each pusher head 12 can optionally be fixedly or removably attached to at least one plate 22. Optionally, as shown in FIG. 11, each pusher head 12 can include at least one passageway 26 sized, shaped and/or configured to receive a fastener that extends through the plate 22 and into the pusher head 12. Alternatively, each pusher head 12 is attached to the plate 22 by another means, such as adhesive, welding or friction-fit, for example. Optionally, each pusher head 12 is molded to the plate 22.

In any optional embodiment, each of the plate 22, the base 34 and the platform 36 extend in parallel. Optionally, a plane in which the platform 36 extends is above a plane in which the base 34 extends. Optionally, the plane in which the base 34 extends is below a plane in which the plate 22 extends. Optionally, the plane in which the platform 36 extends is above the plane in which the plate 22 extends. In such an embodiment, the above configuration is maintained regardless of whether the pusher head(s) 12 is/are in the upper position (see FIGS. 5 and 5A) to the lower position (see FIGS. 6 and 6A).

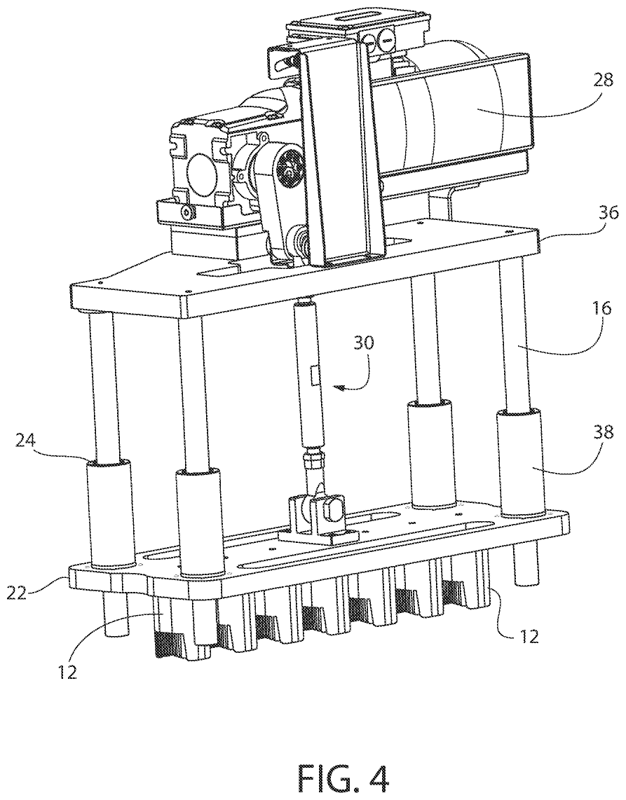

In any optional embodiment, the plate 22 can include at least one hole 24 or passageway extending therethrough (see FIG. 4), which can be sized, shaped and/or positioned to allow the at least one shaft 16 to pass therethrough. The at least one hole 24 can optionally include a plurality of spaced-apart holes 24, such as four holes 24, each being near an outer periphery of the plate 22. Optionally, each hole 24 can correspond with and/or complement one of the shafts 16.

Further, in any optional embodiment, the plate 22 can include, operate in conjunction with, and/or be attached to at least one sleeve 38. The at least one sleeve 38 can optionally be longitudinally aligned with and/or form the at least one hole 24. The at least one sleeve 38 can be sized, shaped and/or configured to receive at least a portion of the at least one shaft 16 therein. A longitudinal axis of the at least one sleeve 38 can optionally extend perpendicular to the plane of the plate 22. In any optional embodiment, the at least one sleeve 38 can include a plurality of spaced-apart sleeves 38, such as four sleeves 38, each of which is aligned with and/or form one of the holes 24.

In any optional embodiment, each shaft 16, hole 24, and sleeve 38 combination can function as, or be considered, a linear bearing. Optionally, an internal surface of each sleeve 38 can include one or more ball bearings to facilitate movement of the sleeve 38 with respect to the stationary shaft 16. However, bearings are not required for the sleeve(s) 38 to function as described herein.

As shown in FIGS. 4-6A, for example, the plate 22 can optionally be operatively connected to a first motor 28. More particularly, in any optional embodiment, the first motor 28 is connected to the plate 22 by at least one shaft or linkage 30. The first motor 28 can be located above the plate 22. However, the presently disclosed technology is not limited to such a configuration, as the first motor 28 can be placed in different locations to achieve the desired vertical movement of the plate 22, assuming that the at least one shaft or linkage 30 is modified to accommodate the different positions.

Optionally, a top or upper end of the linkage 30 is rotatably attached to a portion of the first motor 28. For example, a pivotable joint or a rotatable linkage can connect the linkage 30 to the first motor 28. Optionally, a lower or bottom end of the linkage 30 is rotatably attached to at least a portion of the plate 22. For example, a pivotable joint or a rotatable linkage can connect the linkage 30 to at least a portion of the plate 22. The first motor 28 can optionally be placed on or directly attached to (e.g., fixed to) a top surface of the platform 36. In operation, rotation of at least a portion of the first motor 28 raises and lowers the linkage 30, which in turn raises and lowers the plate 22, as guided or constrained by the at least one shaft 16.

Optionally, the assembly 10 can include means for moving sliced or cut object(s) 11 (or portions thereof) from beneath or away from the blade(s) 14. In any optional embodiment, the means for moving is or can include at least one conveyor. In any optional embodiment, the means for moving is or can include at least one first conveyor belt 18, one or more rails configured to guide one or more carriages or containers, or similar configurations.

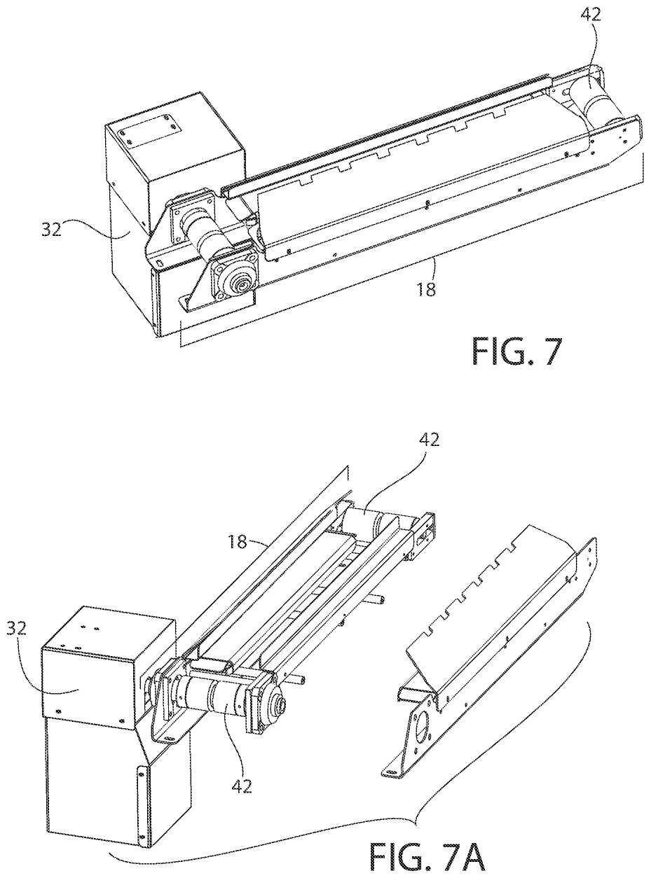

Optionally, as shown in FIGS. 7 and 7A (if only schematically or representative), the conveyor belt 18 can wrap around two or more spaced-apart spindles 42 and/or extend along the first axis F_{A}. A longitudinal axis of each spindle 42 can extend perpendicular to the first axis FA. The conveyor belt 18 can be designed and/or oriented to receive the sliced mid-portion section or “good” slices of each object 11 placed in the assembly 10 and move these sections or slices to the tray 13.

The means for moving sliced or cut object(s) 11 from beneath or away from the blade(s) 14 can optionally include or be operatively connected to a second motor, which is optionally contained or housed within a box 32 shown in FIGS. 7 and 7A. Optionally, the second motor can be configured to move or rotate the conveyor belt 18. For example, the second motor can be configured to rotate at least one or each of the spindles 42 at the same speed. The second motor can optionally be configured to operate in conjunction with or separate from the first motor 28. For example, in any optional embodiment, when a “Power” or “On” button or switch (e.g., a second button) activates the first motor 28 (e.g., upon engagement by a user), the second motor can be activated. The second motor may drive the conveyor belt 18 to move continuously or alternatively, incrementally (i.e., start-stop).

As shown in FIGS. 1-3, the assembly 10 can optionally include at least one or a plurality of spaced-apart wheels 44. In any embodiment, each of four legs of the assembly 10 can include one of the wheels 44, which allows the entire assembly 10 to be easily movable. Optionally, each wheel 44 can be a castor-style wheel, optionally including a pivoting lever that serves as a break to prevent that particular wheel from rotating.

The presently disclosed technology includes methods for assembly, partial assembly, and/or use of the assembly 10. One optional method of slicing the object(s) 11 includes allowing at least a mid-portion (e.g., the “good” slices) of each object 11 to move, fall or drop downwardly on the conveyor belt 18 or other transporter to move the object from one place to another. Optionally, at least one end-portion (e.g., a “bad” slice) of each object 11 moves, falls or drops at an angle approximately perpendicular to the direction in which the mid-portion(s) moves. Stated differently, in one embodiment, the interior or “good” slices of the object(s) 11 move onto the conveyor belt 18 or other transporter, and the end(s) or “bad” slice(s) of the object(s) 11 move(s) laterally (and optionally downwardly) away from the conveyor belt 18 or other transporter, such as into a receptacle. This distinct movement of different slices can be the result of guards or ramps placed at key locations to direct the desired movement of the slices.

In one optional method of the presently disclosed technology, the user places one of the objects 11 in each of the cavities 40. Next, the user activates the first motor 28 (e.g., upon depressing or engaging a first button), which causes the linkage 38 to move the plate 22 downwardly. As a result, each pusher head 12 moves downwardly to contact one object 11 and press that object 11 downwardly through the blades 14. The interior or “good” slices of the object 11 fall downwardly on the moving conveyor belt 18 or other transporter, which is driven by the second motor. The conveyor belt 18 or other transporter optionally deposits these “good” slices in the tray 13 located at one end of the conveyor belt 18 or other transporter. The first motor 28 can optionally automatically move the pusher head 12 and/or the plate 22 upwardly (e.g., to a high position) after a predetermined period of time in which the pusher head 12 and/or plate 22 is in a low position (see, e.g., FIGS. 6 and 6A).

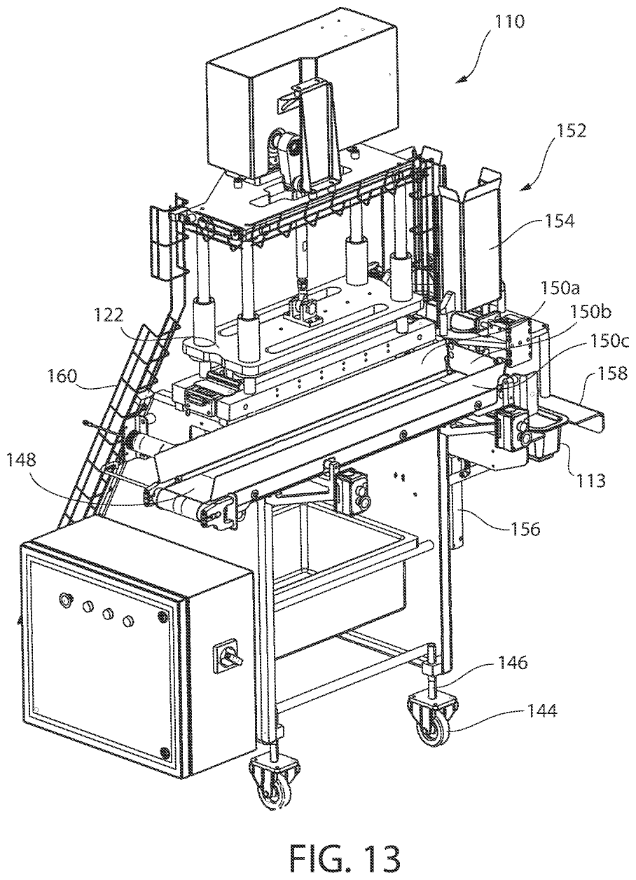

FIGS. 13-15 show another embodiment of an assembly 110 according to the presently disclosed technology. Similar or identical structure as between the embodiment of FIGS. 1-12 and the embodiment of FIGS. 13-15 is distinguished in FIGS. 13-15 by a reference number with a magnitude one hundred (100) greater than that used in FIGS. 1-12. Similarities between the embodiment of FIGS. 1-12 and the embodiment of FIGS. 13-15 are incorporated by reference below. Description of certain similarities between the embodiment of FIGS. 1-12 and the embodiment of FIGS. 13-15 may be omitted herein for convenience and brevity only. At least certain differences between the assembly 10 of the above-described embodiment and the assembly 110 of the present embodiment are highlighted here.

A distinguishing feature of the assembly 110 of the present embodiment is that at least a portion of a frame that forms the assembly 110 is adjustable so as to be slanted or angled. More particularly, in any embodiment, one or more of the legs 146 that optionally attached to a wheel 144 is adjustable. Optionally, a height of one or more of the legs 146 can be selectively modified. Several different configurations can be used to accomplish this adjustability. One option is that each leg 146 extends through a passageway formed in a bracket. The bracket can optionally be loosened to allow a portion of the leg 146 to move upwardly and/or downwardly therein, and then the bracket can be tightened to lock or secure the leg 146 in a new position (e.g., height).

This adjustability allows the user to at least slightly tilt the entire assembly 10 during use, but not necessarily storage or transportation. Thus, the adjustability eliminates any flat surfaces on or in the assembly 110 during use, and eliminates the ability of water or moisture (e.g. that may emanated from the object(s), to become stagnant or pool. Thus the assembly 110 of the present embodiment is a sanitary design. In contrast, certain prior art slicers are built with angles or slanted surfaces that are present even when the slicer is in a storage or transport position. Such a prior art design complicates and increases the cost of manufacturing.

Another distinguishing feature of the assembly 110 of the present embodiment is means for moving whole or uncut object(s) from a place of storage or preparation to proximate the plurality of spaced-apart blades and/or the plate 122. The means for moving can help a user quickly and efficiently place one or more uncut objects into the cavities to be sliced. In any optional embodiment, the means for moving is or can include at least one conveyor. In any optional embodiment, as shown in FIG. 13, the means for moving is or can include at least one second conveyor belt 148, one or more rails configured to guide one or more carriages or containers, or similar configurations.

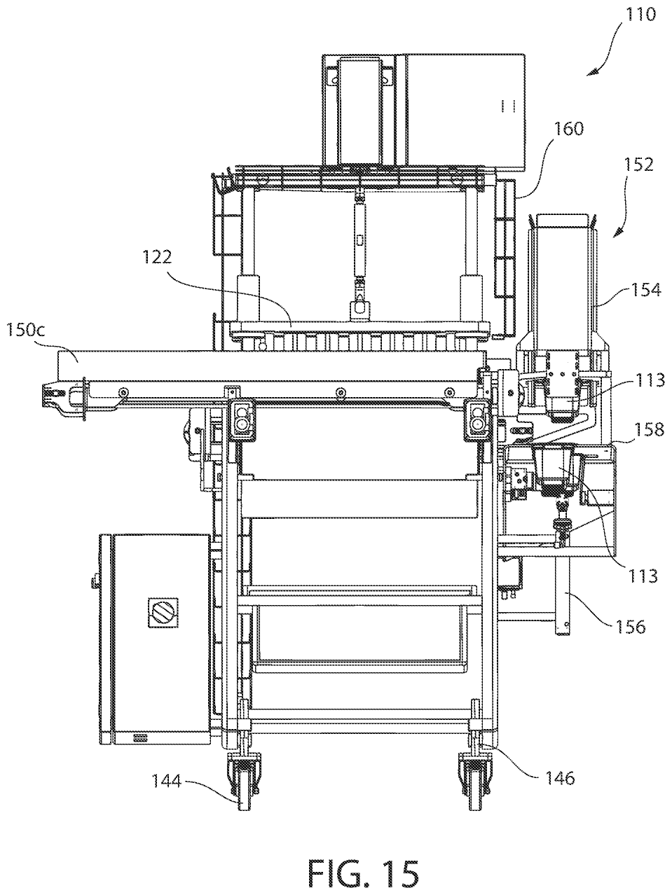

One, two or three sides of the means for moving can include a sidewall 150a, 150b, 150c to help prevent object(s) from inadvertently falling off of the means for moving. Each sidewall 150a, 150b, 150c can optionally be slanted or angled so as not to impede the movement or path of the object(s). Optionally, the means for moving moves from left to right in FIGS. 13 and 15, such that a left side of the means for moving does not include a sidewall to allow objects to be placed on the means for moving.

Optionally, the second conveyor belt 148 can extend parallel to and spaced-apart from the first conveyor belt, which is described in detail above with respect to the first embodiment. The second conveyor belt 148 can optionally be at least slightly higher than the first conveyor belt with respect to a ground surface and/or the wheel(s) 144. The second conveyor belt 148 can be formed from similar or identical components, and in a similar or identical configuration, and the first conveyor belt.

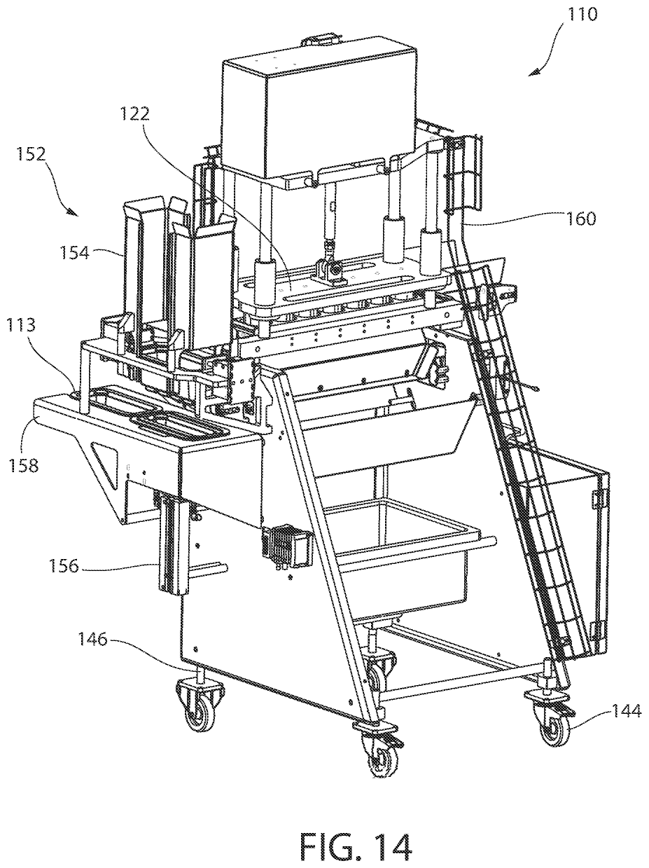

Yet another distinguishing feature of the assembly 110 is a de-nester apparatus 152 for a plurality of trays 113. The de-nester apparatus 152 can include a holding bin 154 positioned above a location where the first conveyor belt deposits the “good” slices of the object(s). The holding bin 154 can be configured to support and/or suspend a plurality of nested trays 113 a predetermined distance above the location where the first conveyor belt deposits the “good” slices of the object(s). As shown in FIGS. 13 and 14, a side of the holding bin 154 facing away from a remainder of the apparatus 110 can be open or exposed to reveal the existence or number of the trays 113 therein. An upper or top end of the holding bin 154 can be tapered outwardly to facilitate insertion of the trays 113 into the holding bin 154 from above.

The de-nester apparatus 152 can optionally include a movable arm 156 positioned below the location where the first conveyor belt deposits the “good” slices of the object(s). The movable arm 156 can be configured to reach and/or extend upwardly to at least temporarily engage and then separate the lowest tray 113 of the nested trays 113 from the other nested trays 113 as it pulls the lowest tray 113 downwardly to sit or rest on a stationary platform 158 slightly below the location where the first conveyor belt deposits the “good” slices of the object(s). At least a portion of the movable arm 156 can be limited to movement in only one direction (e.g., vertical).

In operation, once the first conveyor belt places and/or deposits the “good” slices into the lowest tray 113, the lowest tray 113 can move laterally (either manually or automatically) on the stationary platform 158 to make room for another empty tray (e.g., the previously second lowest tray 113) to be moved from the holding bin 154 to the stationary platform at least slightly below the location where the first conveyor belt deposits the “good” slices of the object(s). Optionally, as shown in FIG. 14, the stationary platform 158 can be sized, shaped, and/or configured to support two or more trays 113 in a linear configuration

As shown in FIGS. 13-15, optionally a shoot or pathway 160 extends at least partially around, up, and/or down one or more portions of the assembly 110. In any optional embodiment, the shoot 160 can be a wire frame that forms a channel for one or more of the objects to be held and/or move around and/or throughout the assembly 110. At least in certain portions, the shoot 160 has a circular cross-section.

The shoot 160 can be configured to receive and/or hold one or more wires or cables (not shown), which can provide power or electricity to the assembly 110. Optionally, the shoot 160 forms a cable tray that conforms to sanitary design standards for wash-down compliance. In particular, the generally open configuration of the shoot 160 allows one or more wires therein to be easily accessed and/or cleaned, for example following use of the assembly 110.

The following exemplary embodiments further describe optional aspects of the presently disclosed technology and are part of this Detailed Description. These exemplary embodiments are set forth in a format substantially akin to claims (each with numerical designations followed by a letter, e.g., 1A, 2A, 3A, 1B, 2B, etc.), although they are not technically claims of the present application. The following exemplary embodiments refer to each other in dependent relationships as “embodiments” instead of “claims.”

1A. An apparatus for slicing at least two objects, the apparatus comprising:
at least one pusher head;
at least two spaced-apart blades; and
at least one conveyor belt,
wherein the pusher head is movable from a first position to a second position to slice each of the objects.

2A. The apparatus of embodiment 1A, wherein the pusher head is located above each blade when the pusher head is in the first position.

3A. The apparatus of embodiment 1A or 2A, wherein the conveyor belt is located beneath the pusher head and the blades such that sliced objects fall onto the conveyor belt.

4A. The apparatus of any one of embodiment 1A-3A, wherein blades are stationary while the pusher head moves from the first position to the second position.

1B. An apparatus for slicing at least one object, the apparatus comprising:
at least one pusher head; and
at least two spaced-apart blades;
wherein the pusher head is movable from a first position to a second position to slice each of the objects, and wherein the blades are stationary during movement of the pusher head from the first position to the second position.

2B. The apparatus of embodiment 1B, further comprising:
at least one conveyor belt configured to move sliced portions of each of the objects away from the pusher head and the blades.

3B. The apparatus of embodiment 1B or 2B, wherein the at least one pusher head includes a plurality of spaced-apart pusher heads, wherein the at least two spaced-apart blades includes a plurality of spaced-apart blades.

1C. A slicer comprising:
at least two linear bearings configured to move a pusher head downwardly onto an object to be sliced, which in turn moves the object through at least two stationary blades.

2C. The slicer of embodiment 1C, wherein the slicer further comprises a conveyor belt configured to receive only some sliced portions of the object and move the sliced portions away from the blades and the pusher head.

It will be appreciated by those skilled in the art that changes could be made to the embodiments described above without departing from the broad inventive concept thereof. It is understood, therefore, that the presently disclosed technology is not limited to the particular embodiments disclosed, but it is intended to cover modifications within the spirit and scope of the present invention as defined by the appended claims.

1. A slicing apparatus comprising:
at least two spaced-apart blades;
at least one motor; and
at least one pusher head operatively connected to the motor and configured to move with respect to the blades, the pusher head being configured to move between a first position wherein at least one object to be sliced is capable of being placed between the pusher head and the blades and a second position wherein the pusher head pushes the object downwardly against the blades to slice the object
wherein the blades are stationary during movement of the pusher head from the first position to the second position.

2. (canceled)

3. The slicing apparatus of claim 1, wherein the blades extend in parallel.

4. The slicing apparatus of claim 1, further comprising:
at least one linear bearing being fixed to the pusher head and operatively connected to the motor, the linear bearing being configured to limit movement of the pusher head along a single axis.

5. The slicing apparatus of claim 1, wherein the pusher head is attached to a plate extending parallel to a plane defined by the blades, the plate being fixedly attached to or including at least one linear bearing, a first end of a shaft of the linear bearing being fixed to a platform, an opposing second end of the shaft being fixed to a base configured to hold the blades in a fixed position.

6. The slicing apparatus of claim 1, wherein the at least one pusher head includes a plurality of spaced-apart pusher heads, and wherein the at least two spaced-apart blades includes a plurality of spaced-apart blades.

7. The slicing apparatus of claim 6, wherein the plurality of spaced-apart pusher heads are spaced-apart along a first axis, wherein the plurality of spaced-apart blades are spaced-apart along a second axis, and wherein the first axis extends in a direction ninety degrees with respect to the second axis.

8. The slicing apparatus of claim 4, wherein the at least one linear bearing includes at least two spaced-apart linear bearings.

9. (canceled)

10. The slicing apparatus of claim 1, wherein each pusher head includes a plurality of spaced-apart fins on a lower surface thereof, each fin being configured to contact the object to be sliced and push the object to be sliced past each blade.

11. The slicing apparatus of claim 1, further comprising:
means for moving sliced portions of the object to be sliced away from the blades and the pusher head.

12. The slicing apparatus of claim 11, wherein the means for moving includes a conveyor belt, and wherein the conveyor belt extends along the first axis.

13. (canceled)

14. The slicing apparatus of claim 1, further comprising:
means for moving the object to be sliced toward the blades and the pusher head.

15. The slicing apparatus of claim 14, wherein the means for moving includes a conveyor belt, and wherein the conveyor belt extends along the first axis.

16. (canceled)

17. The slicing apparatus of claim 15, further comprising at least one adjustable foot configured to at least slightly tilt the slicing apparatus to prevent the pooling of liquid thereon.

18. A slicing apparatus comprising:
a base including a plurality of spaced-apart cavities and a plurality of spaced-apart blades, each cavity being configured to support an object to be sliced above the blades;
a plate positioned above the base and including a plurality of spaced-apart pusher heads and a plurality of spaced-apart sleeves;
a platform positioned above the plate and supporting a motor, the motor being operatively connected to the plate to move the plate between a first position and a second position; and
a plurality of spaced-apart shafts, a first end of each shaft being attached to the base and a second end of each shaft being attached to the platform, each shaft extending through one of the sleeves of the plate.

19. The slicing apparatus of claim 18, wherein activation of the motor moves the platform to force at least a portion of each pusher head on to one object to be sliced, which pushes each object to be sliced past the plurality of spaced-apart blades.

20. The slicing apparatus of claim 18, wherein a linkage connects the motor to the plate, wherein the linkage is attached to the plate at a geometric center of a top surface of the plate.

21. (canceled)

22. The slicing apparatus of claim 18, wherein the platform extends parallel to the plate.

23. The slicing apparatus of claim 18, further comprising:
a conveyor belt extending beneath the blades, the conveyor belt being configured to move slices of the object away from the blades.

24. The slicing apparatus of claim 18, further comprising:
a holding bin configured to suspend a plurality of nested trays a predetermined distance above a location adjacent one end of the conveyor belt.

25. The slicing apparatus of claim 24, further comprising:
a movable arm positioned below the holding bin, the movable arm being configured to separate a lowest one of the plurality of nested trays from a remainder of the plurality of nested tray.

26. The slicing apparatus of claim 23, further comprising:
a second conveyor belt extending adjacent to the base, the second conveyor belt being configured to move the objects to be sliced toward the blades.

27. The slicing apparatus of claim 18, further comprising:
a conveyor belt extending adjacent to the base, the conveyor belt being configured to move the objects to be sliced toward the blades.

28. (canceled)

29. (canceled)

30. (canceled)

31. (canceled)

32. (canceled)

33. (canceled)

34. (canceled)

35. (canceled)
